(19) United States
(12) Patent Application Publication
(10) Pub. No.: US 2010/0175271 A1
(43) Pub. Date: Jul. 15, 2010

(54) Compression Indicator

(76) Inventor: Christer Lundborg, Karlskrona (SE)

Correspondence Address: HARNESS, DICKEY & PIERCE, P.L.C., P.O. BOX 8910, RESTON, VA, 20195, US

(21) Appl. No.: 12/223,278

(22) PCT Filed: Feb. 22, 2007
(86) PCT No.: PCT/SE2007/050105

§ 371 Date: Oct. 13, 2009

(30) Foreign Application Priority Data
Feb. 24, 2006 (SE) 0600420-4

(51) Int. Cl. G01D 21/00; B23P 15/00

(52) U.S. Cl. 33/613; 29/888.02

(57) ABSTRACT

At least one embodiment of the present invention is directed to a method of controlling the compression of a compression unit placed inside a frame. At least one embodiment is directed to indicator clips to be used in controlling the compression, which indicator clips may have different designs. In one embodiment the indicator clip has an elongated form with two rounded ends. The rounded ends are to be placed on stems of two screws of the compression unit. The compression of the compression unit increases with a distance from the screw head of each screw to the compression unit. The width of the indicator clip is adapted to said distance at the desired compression.

### TECHNICAL FIELD

The present invention concerns a compression indicator. It also concerns a method of using an indicator clip as compression indicator.

### PRIOR ART

The indicator is to be used with a compression unit of a frame for cable entries, cable transits or pipe penetrations. The cable entries, cable transits or pipe penetrations have the form of modules that are compressed around the cable or pipe in order give a tight seal. Normally a number of modules are received inside the frame together with a compression unit, placed to compress the modules. Furthermore, partitions are often placed between modules at different levels within the frame.

In the compression unit it is common to have one or more screws or the like, which are turned to give the desired compression. Many suppliers of compression units stipulate a certain torque with which the screws or the like should be drawn to give a desired compression. However, in such a case there is no swift and easy way to control the compression afterwards.

When mounting and installing cable entries, cable transitions or pipe penetrations, it is often up to the skill of the installer to get the correct compression. It is often important to avoid a too high compression as well. Normally the screws have a stop hindering that they are screwed out too far.

### SUMMARY OF THE INVENTION

The present invention is developed for compression units having screws to control the compression. The compression unit may have the form of a wedge. Such a wedge normally has interacting parts with oblique contact surfaces, whereby the interacting parts move in relation to each other, increasing or decreasing the outer dimension of the compression wedge. The screws of the compression wedge are screwed outwards, i.e. the distance between the screw head and the compression wedge is increased to increase the compression force. Thus, the distance between the screw head and the compression wedge is an indicator of the applied compression force.

There is a need for a method of controlling the compression, which method should be easy to apply and not involve too high costs. According to the invention, the compression is controlled by placing an indicator clip on the stem of one or more screws of the compression unit. The width of the indicator clip is adapted to the desired compression. If the available space is not enough to be able to place the indicator clip on the one or more screws, the compression should be increased until the indicator clip can be placed on the one or more screws.

It is possible to mark the indicator clips in different ways, by colour, letters, numbers and other signs. The different markings may of course be used together in different ways. By such marking it is possible to identify the person responsible for the control of the compression and/or the installation of cables and/or pipes.

The frames of the described kind are often placed in relatively harsh environments. The indicator clips are therefore also formed to protect the threads of the screws in some extent from dust, mud etc.

Depending on the requirements of the different installations it is possible to use indicator clips having different widths. If the requirements are less severe, the applied compression force may be less than for more sensitive installations.

### BRIEF DESCRIPTION OF THE DRAWINGS

The invention will described more closely below by way of examples and with reference to the enclosed drawings. In the drawings:

FIG. 1 is a perspective view of one example of a frame with which the present invention may be used;

FIG. 2 is a side view of the frame of FIG. 1; and

FIGS. 3-14 are views of different designs of compression indicators according to the present invention.

### DETAILED DESCRIPTION OF PREFERRED EMBODIMENTS

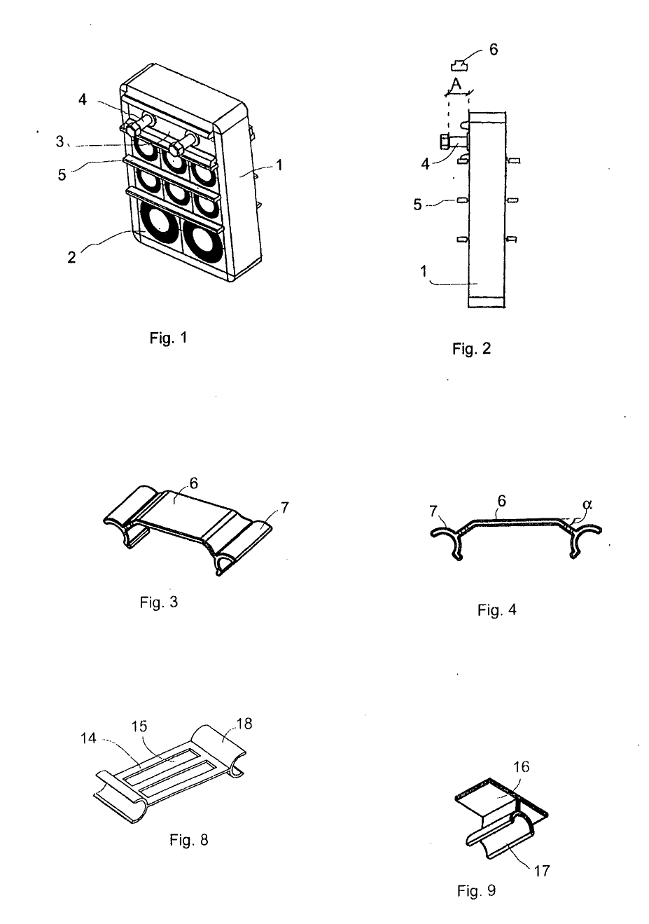

In the example of FIG. 1 a frame 1 is shown, which frame 1 is intended to be received in an opening of a wall, a roof, a floor or a bottom of a house, a ship, an electrical cabinet, a container etc. The wall, roof, floor or bottom could be expressed as any dividing structure or partition. Inside the frame a number of modules 2 are shown. In each module 2 a cable or a pipe may be received. In the shown embodiment the modules 2 are of a kind having a number of centrally placed sheets, that may be peeled of to adapt the size of the opening of each module 2 to the diameter of the cable or pipe to be received in the module 2. Between the different rows of modules 2 partitions 5 are normally placed. Furthermore, a compression unit 3, here in the form of a compression wedge, is placed inside the frame 1. The compression unit 3 has two screws 4 by means of which the size of the compression unit 3 is altered. By increasing the size of the unit 3 or wedge, by means of the screws 4, the modules 2 will be compressed increasing the pressure against the cables and pipes of each module 2. Thus, by means of the compression unit 3 a tight seal of each cable and/or pipe is established.

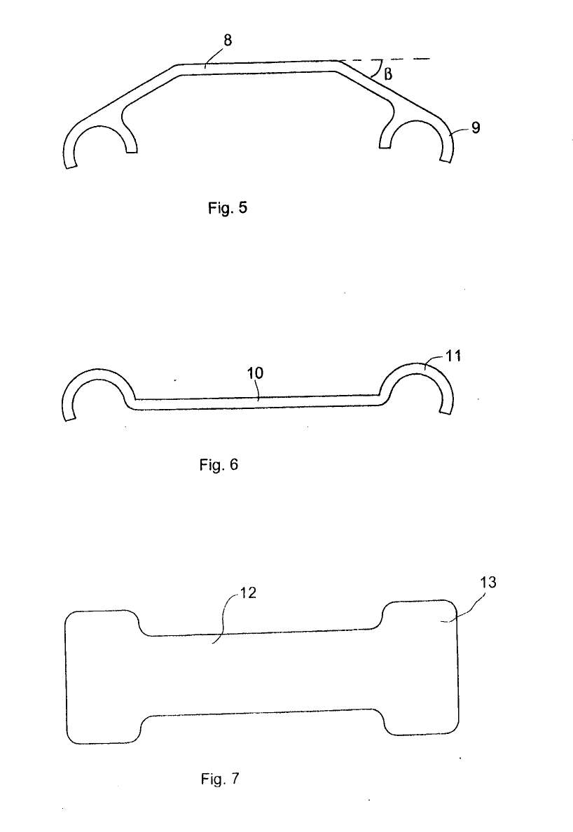

The present invention is directed to compression units 3 having a design that is such that the compression is increased the further the screws 4 are screwed out of the compression unit. Thus, the compression increases when a distance A from the compression unit 3 to the screw head increases (see FIG. 2). In order to have a sufficient compression the distance A should in each specific case have a minimal value.

To control the distance indicator clips 6, 8, 10, 12, 14, 16 have been designed in accordance with the present invention. The widest part of each indicator clips 6, 8, 10, 12, 14, 16 is adapted to the desired minimal distance A between the compression unit 3 and the head of each screw 4.

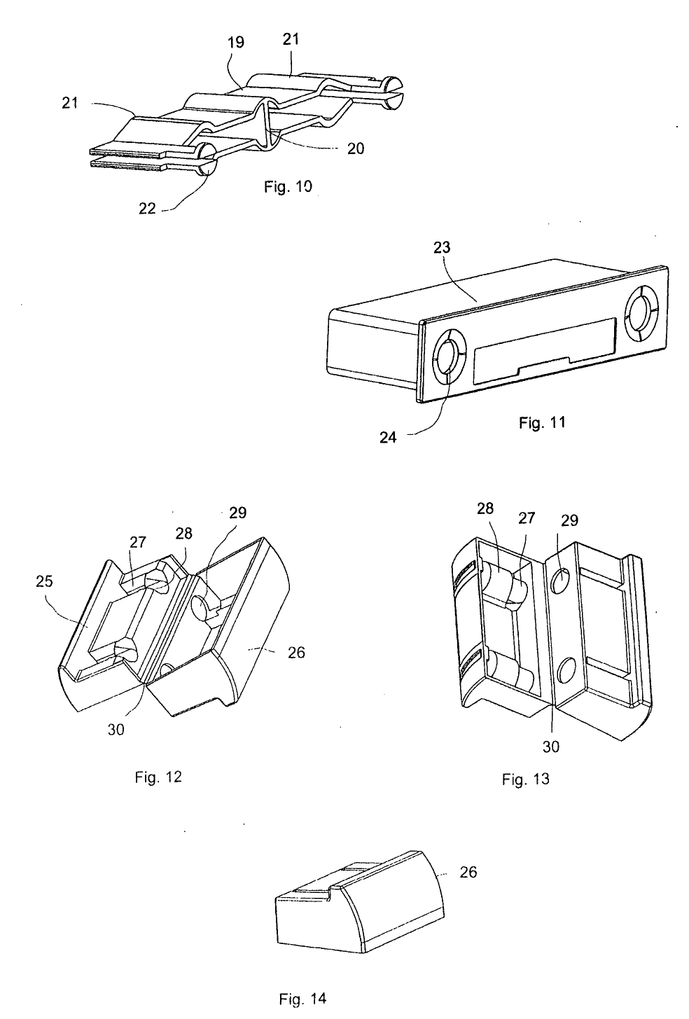

The clip 6 of FIGS. 3 and 4 has two rounded ends 7 adapted to fit and be snapped around the stem of the screws 4 of the compression unit 3. The width of the ends 7 of the indicator clip 6 is adapted to the distance A at the desired compression. Thus, if the indicator clip 6 can be placed on the screws 4 of the compression unit 3, the compression inside the frame 1 is sufficient.

The ends 7, 9, 11, 13, 18 of the indicator clip 6, 8, 10, 12, 14, will to some extent cover the threads of the screws 4 and protect them from dust or other dirt. The exact design of the indicator clips 6, 8, 10, 12, 14, 16 may vary as long as they fulfil the intended function of controlling the compression. In FIGS. 3-9 a number of different designs are indicated.

The part of the clip between the ends may have the same width as the ends (FIGS. 3-6, 8, 9) or may have a smaller width (FIG. 7). In some embodiments the ends 7, 9 are placed at an angle α, β to the central part of the clip 6, 8 (FIGS. 4, 5). The central part may have a number of through grooves 15 (FIG. 8), to save weight and material costs.

The rounded ends 7, 9, 11, 13, 18 normally have the form of a part of a circle, often a semicircle, seen in side view. The part of the circle has an extension of at least 45°, preferably at least 90° and most preferred at least 180°. The radius of the part of the circle is adapted to the size of the stem of the screw 4 on which the respective rounded end 7, 9, 11, 13, 18 is to be received. In some embodiments a rubber gasket or coating is placed inside the rounded ends, thus, between the rounded ends 7, 9, 11, 13, 18 and the screws 4.

The angles α, β at which the ends 7, 9 are placed in relation the central parts of the indicator clips 6, 8 of FIGS. 4 and 5 may vary. Often the angles are in the range of 5° to 60°, preferably 10° to 50°, and most preferred 25° to 35°.

Even tough the indicator clip 14 of FIG. 8 is shown having two grooves 15, a person skilled in the art realises that clips having any number of grooves may be used. Furthermore, the form and size of the grooves may vary. In some embodiments the grooves are replaced by a number of openings.

The compression clip is normally made of plastic or aluminium and may be produced by any suitable method, such as extrusion or moulding.

Some compression wedges have only one screw. For that type of compression wedges the indicator clip 16 has only one rounded part 17, to be placed around the stem of the screw. Furthermore, it has a straight, level part placed at a distance above the rounded part.

In use the compression clip 6, 8, 10, 12, 14, 16 is placed on the screws 4 of the compression unit 3. If the distance between the compression unit 3 and the head of each screw 4 is too small to receive the rounded parts of the indicator clip 6, 8, 10, 12, 14, 16, the screws 4 should be screwed out further until the indicator clip 6, 8, 10, 12, 14, 16 can be received. If the indicator clip 6, 8, 10, 12, 14, 16 cannot be received the compression of the compression unit 3 is not at the minimal predetermined compression. On the other hand if the available space for the indicator clip 6, 8, 10, 12, 14, 16 is much larger than the width of the indicator clip 6, 8, 10, 12, 14, 16, it is an indication that the compression unit 3 may have been compressed to much and that the screws should 4 be screwed inward to decrease the compression.

In alternative embodiments the clips have a somewhat different design. In the example of FIGS. 10 and 11 the indicator clip 19 is formed of two elongated parts with a central joint 20. The two parts of the clip 19 have rounded parts that together form grooves 21 to receive the stem of screws 4 of the compression wedge 3. Furthermore, the two parts of the clip 19 forms two inserts 22 projecting from each end of the clip 19. The inserts 22 are to be received in openings 24 of a cover 23. Thus, the cover 23 is to be placed above the clip 19, when the clip is received on the screws 4 of the compression wedge 3. By means of the cover 23 the threads of the screws 4 will be protected from dust, dirt etc. In use the ends of the clip 19 are bent outwards to place the clip 19 between the screws 4. If the screws 4 have been screwed out sufficiently to give the desired compression there will enough room to receive the clip 19, corresponding to the distance A as discussed above in connection with the other clips. Then the cover 23 is placed on the clip 19 with the inserts 22 of the clip 19 received in the openings 24 of the cover 23.

In the embodiment of FIGS. 12-14 the clip has an inner part 25 and an outer part 26 that are mutually foldable along an edge 30 connecting the two parts 25, 26. The stems of the screws 4 of the compression unit 3 are to be received in grooves 27 of the clip, which grooves 27 goes over in a part 28 with increased diameter to receive the screw heads. The parts 28 with increased diameter shall receive the screw heads. The outer part 26 of the clip has openings 29, through which the screws 4 of the compression unit 3 are to go. In use the outer part 26 of the clip is placed on the screws 4, in that the screws 4 are received in the openings 29 of the outer part 26. The outer part 26 is pushed all the way into contact with the compression unit 3 and then the inner part 25 is folded to a position inside the outer part 26. If the inner part 25 is completely received inside the outer part 26, as indicated in FIG. 19 the compression is correct. However, if the inner part 25 extends somewhat below the outer part 26 the compression is too low and the screws 4 should be screwed outwards until the inner part 25 may be completely received inside the outer part 26. The inner part 25 will be completely received inside the outer part 26 if the compression is at the pre-determined level, i.e. if the distance A between the screw heads and the compression unit is of a certain size. Thus, if the screw heads are received in the parts 28 of the grooves 27 with increased diameter.

1. A method of controlling the compression of a compression unit comprising:
placing the compression unit in a frame together with at least one compressible module receiving cables or pipes, the compression unit including at least one screw to control the compression;
arranging the at least one screw so that the compression will increase when the distance between the compression unit and the respective screw head increases; and
placing an indicator clip on stems of the at least one screw to control the compression of the compression unit, the indicator clip including a dimension which, in a mounted condition of the clip, is adapted to the distance between the compression unit and the respective screw head at a desired minimum compression of the compression unit.

2. The method of claim 1, wherein indicator clips of different widths are used depending on a predetermined, desired compression value of the compression unit and wherein the compression is increased if the indicator clip is too wide to be received on the screws of the compression unit.

3. The method of claim 1, wherein the indicator clip is placed with its ends on two screws of the compression unit.

4. A compression indicator comprising: an indicator clip configured to be snapped around the stem of at least one screw of a compression unit, the indicator clip having a dimension adapted to a distance between the compression unit and a head of a respective screw at a desired minimum compression of the compression unit.

5. The compression indicator of claim 4, wherein the indicator clip is elongated having two rounded ends configured to be snapped over the stems of two screws of the compression unit and a width of at least parts of the indicator clip is adapted to the desired minimum compression of the compression unit.

6. The compression indicator of claim 5, wherein the width of the rounded ends of the indicator clip corresponds with the distance between the compression unit and the heads of the screws at the desired minimum compression of the compression unit.

7. The compression indicator of claim 5, wherein the indicator clip has a flat central, elongated part.

8. The compression indicator of claim 7, wherein the rounded end parts are placed at an angle to the central part of the indicator clip.

9. The compression indicator of claim 7, wherein the central part of the indicator clip has a number of through grooves.

10. The compression indicator of claim 7, wherein the central part of the indicator clip has a smaller width than the rounded end parts of the indicator clip.

11. The compression indicator of claim 4, wherein the indicator clip has one rounded part to be placed on the stem of one screw of the compression unit and that the width of the rounded part is adapted to the desired minimum compression of the compression unit.

12. The compression indicator of claim 11, wherein the indicator clip has a straight, level part placed at a distance above the rounded part.

13. The compression indicator of claim 4, wherein the indicator clip is formed of two elongated parts placed at a distance from each other and hold together at a central joint, wherein two halves of the indicator clip forms grooves between said parts to receive stems of the screws and wherein the indicator clip has means to receive a cover covering the indicator clip and the screws.

14. The compression indicator of claim 4, wherein the indicator clip is formed of an inner part and an outer part joined foldable at an edge and having means to receive the screws of the compression unit in such a way that the inner part is received inside the outer part at the desired compression of the compression unit, and wherein the indicator clip has grooves with parts of increased diameter, whereby the stem of each screw is to be received in the groove with the screw head inside the part of the groove of increased diameter.

15. The method of claim 2, wherein the indicator clip is placed with its ends on two screws of the compression unit.
